(19) United States
(12) Patent Application Publication
(10) Pub. No.: US 2015/0058099 A1
(43) Pub. Date: Feb. 26, 2015

(54) Devices For Automatically Paying a Toll/Fee

(71) Applicants: Thomas Spinelli, Northport, NY (US); Jahangir S. Rastegar, Stony Brook, NY (US)

(72) Inventors: Thomas Spinelli, Northport, NY (US); Jahangir S. Rastegar, Stony Brook, NY (US)

(73) Assignee: OMNITEK PARTNERS LLC, Ronkonkoma, NY (US)

(21) Appl. No.: 14/010,374

(22) Filed: Aug. 26, 2013

(51) Int. Cl. G07B 15/00

(52) U.S. Cl. CPC G07B 15/00
USPC 705/13

(57) ABSTRACT

A device for automatically paying a fee. The device including: a transponder for emitting an identifying signal responsive to a signal from a fee payment system; a storage device for storing fee payment system information to be emitted in the identifying signal; a display for displaying fee payment information; and a processor for controlling the transponder, storage device and display. Where at least one of the storage device, display or processor is used for both operation of the transponder and for operation of at least one additional function of the device. The device can be one of a cellular phone, pad computer, GPS device, laptop computer and computer. Furthermore, at least one of the transponder, storage device, display and processor can be provided in one of the devices and the other of the transponder, storage device, display and processor can be provided in another device.

### BACKGROUND OF THE INVENTION

1. Field of the Invention

The present invention relates generally to automatically paying a toll/fee on a roadway and, more particularly, to methods and devices for automatically paying the toll/fee in a manner integrated into an automobile's operating system.

2. Prior Art

Currently, most toll roads are equipped with an electronic toll-collection system, such as E-Z Pass in the northeastern United States or Sunpass in the southeastern United States. The electronic toll-collection system detects and processes tolls electronically. Such electronic toll-collection systems are used in many parts of the United States (and abroad), but are very similar in their construction. Basically, the electronic toll-collection systems use a vehicle-mounted transponder that is activated by an antenna on a toll lane. A person's account information is stored in the transponder. The antenna identifies your transponder and reads your account information. The amount of the toll is deducted and you're allowed through and/or a message is generated, such as “Go” or “low balance.” Electronic toll collection is designed to make traffic flow faster, as cars don't have to stop to make a transaction.

Drivers usually have to pay a deposit to obtain a transponder (which is about the size of a deck of cards) and open an account. The user then manages the account by phone or through a web site to check the balance on the account, refill the balance, view recent activity and cancel the account. The transponder is placed on the inside of the car's windshield near the rearview mirror. A transponder is a battery-operated, radio frequency identification (RFID) unit that transmits radio signals. The transponder is a two-way radio with a microprocessor, operating in the 900-MHz band. Stored in this RFID transponder is some basic account information, such as an identification number. A network stores the information numbers and corresponding information, such as name, address, contact, balance, credit card information and instructions for automatically refilling the amount on the account, if any.

Antennas, or electronic readers, are positioned above each toll lane. These antennas emit radio frequencies that communicate with the transponder. The detection zone of an antenna is typically 6 to 10 feet (2 to 3 m) wide and about 10 feet long. These two devices, the transponder and the antenna, interact with the network to complete the toll transaction.

Some electronic toll-collection systems may also include a sensor, such as a light curtain and/or treadles. A light curtain is just a beam of light that is directed across the lane. When that beam of light is broken, the system knows a car has entered. Treadles are sensor strips embedded in the road that detect the number of axles a vehicle has. A three-axle vehicle is charged a higher toll than a two-axle vehicle. These two devices are safeguards to ensure that all vehicles are counted correctly. The sensor can also direct a camera to take a picture of a passing car's license plate if no transponder is detected (and then issue a summons or notice requesting payment).

The transponder devices are generally adhered to a windshield of the automobile with loop and hook fasteners. As such, they are easily lost or stolen. Although they can be removed from the automobile to prevent theft, the hook and fastener tape on the windshield indicates to a thief that the transponder may be in the automobile, such as in the glove compartment. In which case, even if the transponder is removed from the automobile, a thief may still break into the automobile looking for the transponder, causing damage to the automobile.

Furthermore, the transponder operates on battery power and, although only operates when activated by the antenna, eventually needs replacement (since most transponders are not configured to replace the battery). Furthermore, the batteries are susceptible to environmental problems, such as extreme temperatures (hot or cold).

Still further, managing a user account requires making phone call to a state agency assigned to manage the transponders or through a web site managed by the state agency. Although the balance in most cases can be automatically refilled by leaving a credit card on file and instructing the state agency on how much to refill and how often (or when the balance falls below a predetermined amount), credit cards expire or are stolen, leaving them inactive which can result in the account susceptible to a lower balance than is required for most tolls.

Furthermore, the transponders are issued by state agencies and are generally only useful for paying tolls in a certain region. Therefore, travel to another region would require obtaining a transponder for that particular region in advance or waiting on the cash payment toll line while in another toll-collection system region.

### SUMMARY OF THE INVENTION

Accordingly, a device for automatically paying a fee and for performing at least one additional function is provided. The device comprising: a transponder for emitting an identifying signal responsive to a signal from a fee payment system; a storage device for storing fee payment system information to be emitted in the identifying signal; a display for displaying fee payment information; and a processor for controlling the transponder, storage device and display; wherein at least one of the storage device, display or processor is used for both the operation of the transponder and for operation of the at least one additional function of the device.

The device can be one of a cellular phone, pad computer, GPS device and laptop computer. The device further comprise a communication link where the processor controls both the operation of the transponder and the operation of the communication link. The communication link can include a transducer where the processor controls the transducer to communicate both with the fee payment system and for one or more of cellular communication, Bluetooth communication and GPS reception. The storage device can store the fee payment system information and information and content for use with the one of the cellular phone, pad computer, GPS device and laptop computer. The device can further comprise a GPS receiver where the processor controls the transponder for operation of the fee payment system and the GPS receiver for location information useful for operation of one of the cellular phone, pad computer, GPS device and laptop computer. The processor can control the display to display the fee payment information and information used in the operation of one of the cellular phone, pad computer, GPS device and laptop computer. The device can further comprise a power source for providing power for operation of the transponder and operation of the at least one additional function of one of the cellular phone, pad computer, GPS device and laptop computer.

The device can be an automobile. The processor can control the operation of the transponder and the operation of at least one function of the automobile. The device can further comprise a communication link where the processor controls both the operation of the transponder and the operation of the communication link. The communication link can include a transducer where the processor controls the transducer to communicate both with the fee payment system and for one or more of cellular communication, Bluetooth communication and GPS reception. The storage device can store the fee payment system information and information and content for use with the automobile. The device can further comprise a GPS receiver where the processor controls the transponder for operation of the fee payment system and the GPS receiver for location information useful for operation of automobile. The processor can control the display to display the fee payment information and information used in the operation of the automobile. The device can further comprise a power source for providing power for operation of the transponder and operation of the at least one additional function one of the automobile. The transponder can be disposed at one of a dashboard, front grill and headlamp of the automobile.

At least one of the transponder, storage device, display and processor can be provided in one of a cellular phone, pad computer, GPS device and laptop computer and the other of the transponder, storage device, display and processor can be provided in an automobile.

Also provided is a rearview mirror assembly for use with a windshield of an automobile. The rearview mirror assembly comprising: a mirror; and a transponder for emitting an identifying signal responsive to an signal from a fee payment system. The rearview mirror assembly can further comprise an electrical connection for electrically connecting the transponder to one or more of a storage device for storing fee payment system information to be emitted in the identifying signal, a display for displaying fee payment information; a power source for providing power for operation of the transponder and a processor for controlling the transponder, storage device and display; wherein at least one of the storage device, display, power source and processor is used for both the operation of the transponder and for operation of the automobile. The rearview mirror assembly can further comprise: a body portion for at least indirectly supporting the mirror on or near the windshield; and a module removably disposed on the body portion, the module holding the transponder. The module can further hold one or more of a storage device for storing fee payment system information to be emitted in the identifying signal, a processor for controlling the transponder and a power source for providing power for operation of at least the transponder.

### BRIEF DESCRIPTION OF THE DRAWINGS

These and other features, aspects, and advantages of the apparatus of the present invention will become better understood with regard to the following description, appended claims, and accompanying drawings where:

FIG. 1a illustrates a schematic representation of an embodiment of a toll collection system.

FIG. 1b illustrates a schematic representation of a general device of the toll collection system of FIG. 1a.

FIG. 2a illustrates the device of FIG. 1b configured in an automobile/rear-view mirror.

FIG. 2b illustrates the device of FIG. 1b configured in an automobile/dashboard.

FIG. 2c illustrates the device of FIG. 1b configured in an automobile/front grill/headlamp assembly.

FIG. 3 illustrates a display of the device of FIG. 1b having a main-menu interface.

FIG. 4a illustrates a display of the device of FIG. 1b having a fill account sub-menu interface.

FIG. 4b illustrates a display of the device of FIG. 1b having a check balance sub-menu interface.

FIG. 4c illustrates a display of the device of FIG. 1b having a change system sub-menu interface.

FIG. 4d illustrates a display of the device of FIG. 1b having a notifications sub-menu interface.

FIG. 4e illustrates a display of the device of FIG. 1b having an account information sub-menu interface.

### DETAILED DESCRIPTION OF THE PREFERRED EMBODIMENT

Although the term “toll” is used herein, the methods and devices disclosed herein also apply to paying any fee using an electronic toll-collection system, such as parking fees. In this regard, the term “fee” is intended to be general and to encompass payment of tolls. The present methods and devices also have utility in paying other fees while in an automobile, such as for automatically paying for fast food while driving through a drive through window. Furthermore, although described with regard to automobiles, such devices and systems are application to other modes of transportation, such as motorcycles, boats, trains and aircraft. Further, a vehicle is not necessary as the devices and methods described herein can be implemented on hand held electronic devices carried by a person.

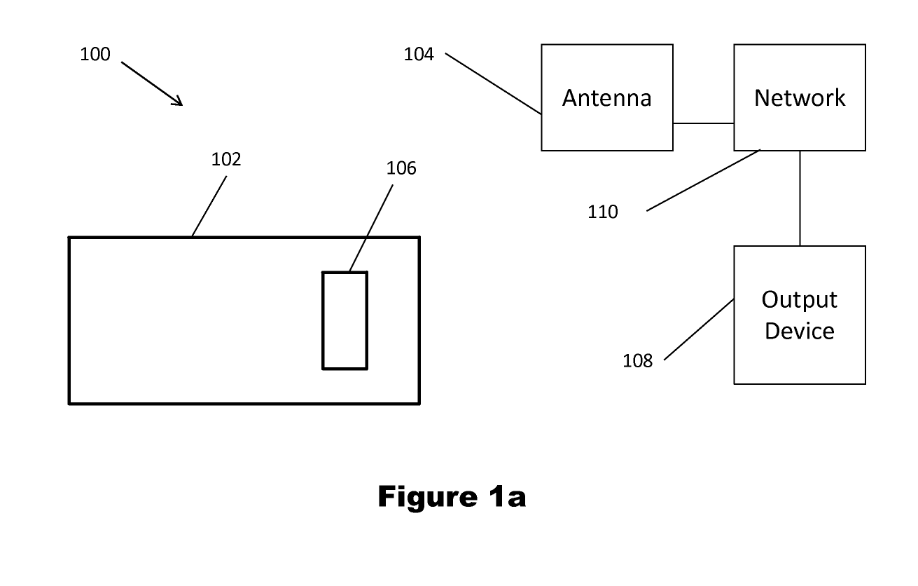

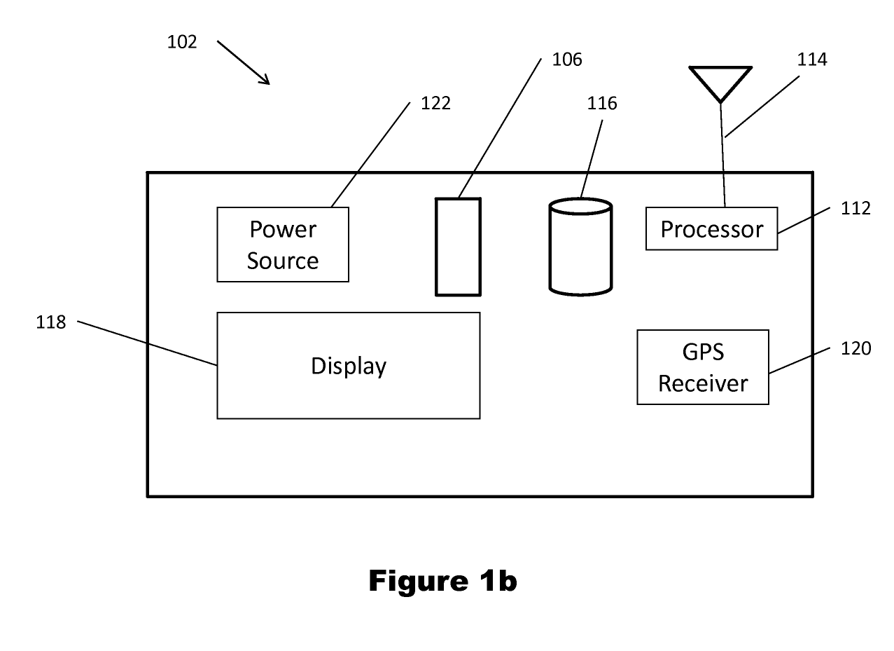

FIG. 1a illustrates a toll-collection system embodiment, generally referred to by reference numeral 100. As a device 102 approaches a toll plaza, a radio-frequency (RF) field emitted from an antenna 104 at the toll plaza activates a transponder 106 in the device. The term transponder as used herein includes a transponder as used in current toll-collection devices carried in automobiles (e.g., adhered to the inside of a windshield) or any combination of hardware and/or software that carries out an equivalent function. The device 102 can be integral with the automobile or separate therefrom, such as being carried by a passenger of the automobile or disposed on an interior or exterior surface of the automobile. The transponder 106 broadcasts a signal back to the lane antenna with information, such as account information. The information is transferred from the antenna to a central database. In general, a lane controller controls an output device 108, such as lane equipment and tracks vehicles passing through. It is networked on a Local area network (LAN). A host computer system connects all of the LANs to a central database via a Wide area network (WAN). The local and wide area networks and associated database are schematically shown in FIG. 1a by reference numeral 110. If the user's account is in good standing (according to the information corresponding to the account information in the database), a toll is deducted from the user's account in which case the output device 108 can be operated, such as opening a toll lane gate and/or displaying a message on a display device indicating that the user can proceed and/or that the user's account balance is low. The entire process takes a matter of seconds to complete. The electronic system records each toll transaction, including the time, date, plaza and toll charge of each vehicle.

With regard to the device 102, the same can be an automobile, cellular phone, computer pad, GPS device, laptop or any portable electronic device. However, the transponder 106 is integrally formed with the device 102, such as by sharing a common component, such as a common transducer, common processor, common memory, common GPS receiver, common display and/or power source. That is, at least one of the components in the device 102 is/are used for both the operation of the transponder and for operation of a different function of the device.

Referring now to FIG. 1b, there is shown a device 102 having such an integral transponder 106. Such device 102 can include a central processor 112, which controls one or more of a transducer 114, a memory 116, a display 118 and a GPS receiver 120. Each of such components can be powered by a power source 122, such as one or more batteries. As discussed above, the device 102 can be an automobile or any portable electronic device, such as a cellular phone, computer pad, GPS device or laptop computer in which at least one of the components in the device 102 is/are used for both the operation of the transponder and for operation of a different function of the device.

With regard to the device 102 being a cellular phone, the processor 112 can control both the operation of the transponder 106 and the operation of the cellular phone; the transducer 114 can communicate both with the antenna 104 and can also be used for cellular communications, Bluetooth communications and/or GPS reception; the memory 116 can be used both to store the toll-collection account information as well as store information and content for use of the cellular phone; the GPS receiver 120 can be used, as discussed below, to operate a function of the transponder and also for location information useful for operation in the cellular phone; the display 118 can display both information, as discussed below, useful in the operation of the transponder as well as displaying typical cellular phone information and/or the power source 122 can power both the transponder operation and the cellular phone operation. A pad computer, GPS device and laptop computer as the device 102 can be similarly configured.

With regard to the device 102 being an automobile, the processor 112 can control both the operation of the transponder 106 and the operation of the automobile; the transducer 114 can communicate both with the antenna 104 and can also be used for cellular, radio, GPS and/or satellite and/or Bluetooth communications; the memory 116 can be used both to store the toll-collection account information as well as store information and content for use of the automobile; the GPS receiver 120 can be used, as discussed below, to operate a function of the transponder and also for location information useful for operation in the navigation system of the automobile; the display 118 can display both information, as discussed below, useful in the operation of the transponder as well as displaying automobile information for the automobile's user interface and/or the power source 122 can power both the transponder operation and the automobile's power consuming components.

Although many of the above described components may be common among the operation of both the transponder 106 and device 102, some of such components may be duplicated, such as being provided in a module for easy assembly in the device 102, as long as the transponder 106 and device share operation of at least one component. Where a module is provided, wiring is provided between such module and device 102 for proper operation. Furthermore, the components of the transponder 106 may be split (or even duplicated) between more than one device 102 (however, such configuration is still referred to herein as a device 102). For example, one device 102 may be an automobile having some of the components and another device 102 may be a cellular phone communicating with the automobile's user interface system by Bluetooth. In this case, the user may operate the toll-collection system using the user-interface of the automobile while other components for the transducer are contained in the cellular phone, or vice versa.

In the case of the device 102 being portable electronic devices, such can be easily held and oriented so that the transponder 106 can communicate with the antenna 104. For example, a GPS device for providing driving instructions is generally placed on a windshield or dashboard and can easily communicate with the antenna 104. Similarly, cellular phones, pad computers and laptop computers can be placed on or near a dashboard of an automobile or held up towards the windshield as it passes a toll collection to communicate with the antenna 104. In the case where the device 102 is the automobile itself, at least the transducer 114 of the transponder 106 can be positioned to be capable of communicating with the antenna 104.

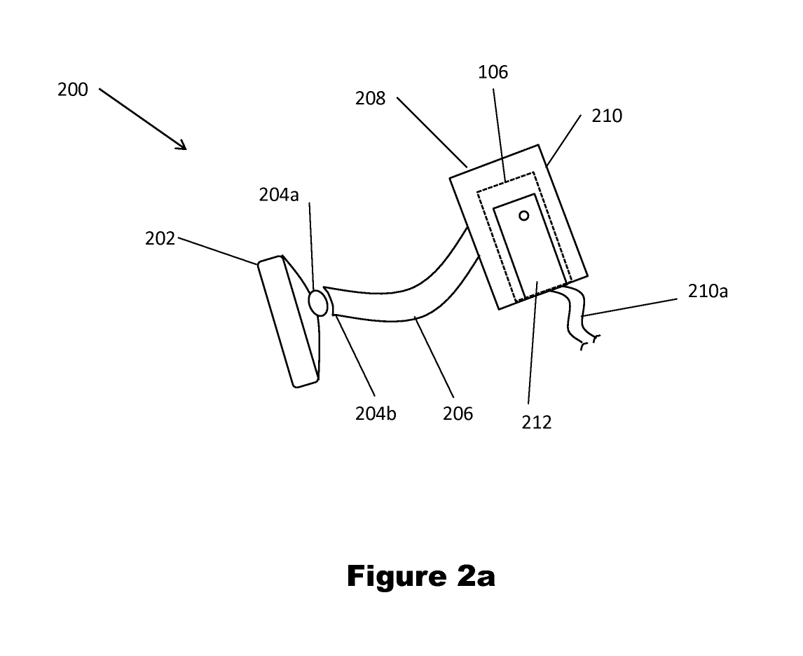

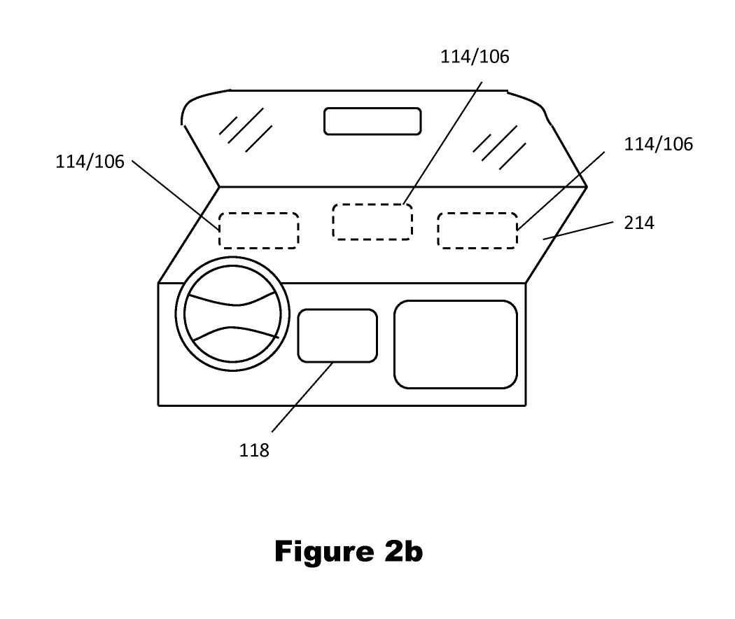

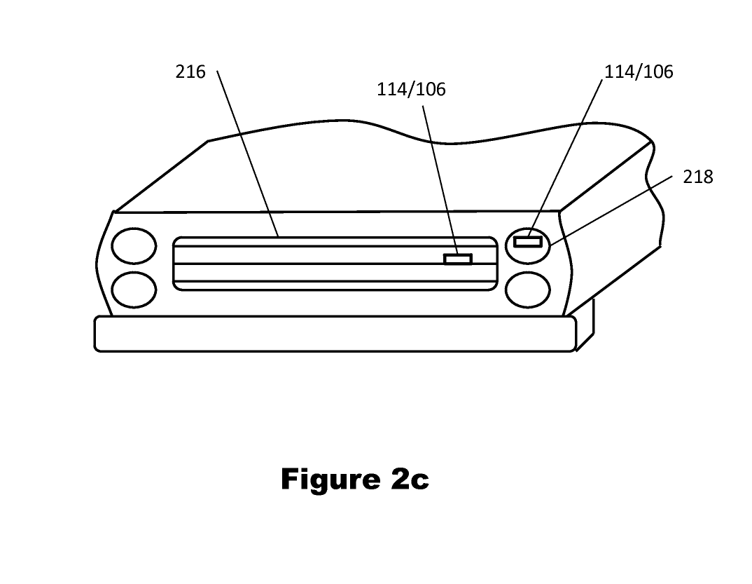

Referring now to FIGS. 2a-2c, some positions of at least the transducer 114 of the transponder 106 are shown. However, as discussed above, the transponder 106 may be provided in a module in such locations and having one or more additional components (besides the transducer 114) for operation of the transponder 106.

FIG. 2a illustrates a rear view mirror, generally referred to by reference numeral 200. The rear view mirror 200 includes a mirror member 202 having a reflective mirror on a surface and generally having a casing holding such reflective mirror. The mirror member 202 having one of a ball or socket 204a, 204b for rotatable connection to a first end of a beam member 206. Another end of the beam member 206 is connected to a base 208 having a surface 210 for attachment to or near a windshield of the automobile (device 102). The base 208 includes a cavity for holding at least the transponder 106. As discussed above, the transducer 114 and any other components may be provided in a module which can be replaced or accessed through an access door 212 on the base 208. The transducer 114 (other components and/or module) can be connected electrically to other components of the device 102 that are common to the automobile, such as the automobiles display device 118 (also referred to as a user interface or vehicle command center) though a connector, schematically shown by wires 210a. The transponder 106 may also be connected wirelessly, such as through a Bluetooth connection to a handheld electronic device, such as a cellular phone through an app running on the hand-held device.

As shown in FIG. 2b, the transducer 114 (other components and/or module) can also be placed at various locations on a dashboard 214 of the automobile. Such transducer 114 should be placed so as not to interfere with the operation of other components of the automobile, such as audio speakers and deployable safety bags. Again, the transducer 114 (other components and/or module) so oriented is connected electrically to other components of the transponder 106 that are common to the automobile, such as the automobiles display device 118. As shown in FIG. 2c, the transducer 114 (other components and/or module) can be positioned on an exterior of the automobile, such as in or on the front grill 216 of the automobile or in a headlamp 218 assembly. Again, the transducer 114 (other components and/or module) so oriented is connected electrically to other components of the transponder 106 that are common to the automobile, such as the automobiles display device 118 or wirelessly to another device, such as a cellular phone.

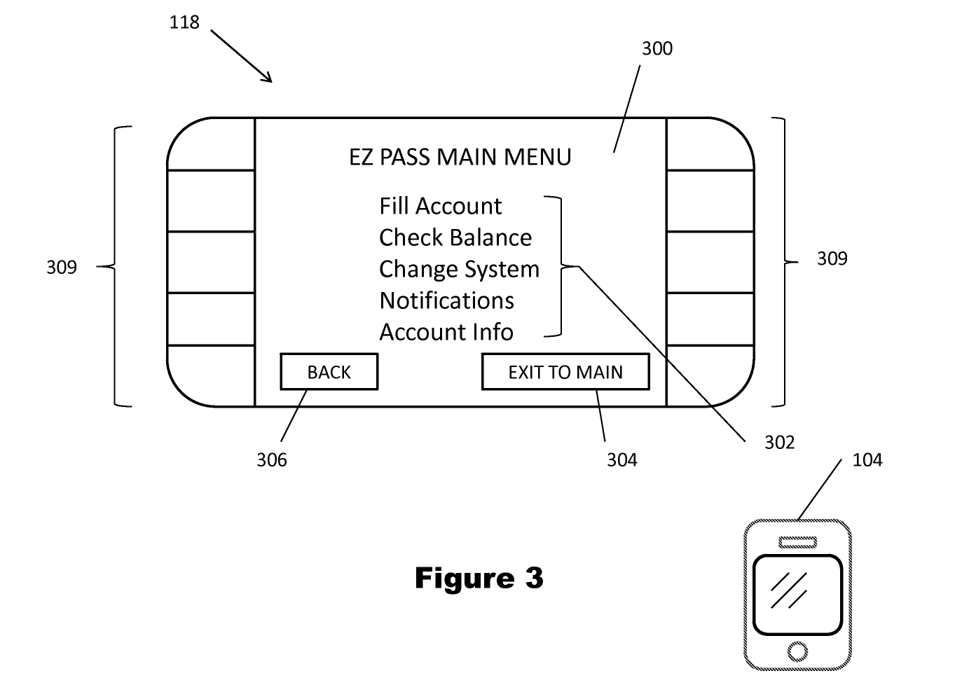

Referring now to FIG. 3, there is shown the display device 118 of the transponder, which can be shared with the device 102. In the case of the device 102 being an automobile, the display 118 can be a vehicle command center display, which can be operated with buttons, pointing device, joystick or a touch screen, to navigate through a user interface for operating the transponder 106. However, such display 118, as discussed above, may also be a display of a cellular phone or pad computer running software from an app to generate a user interface for operating the transponder 106. As discussed above, another device 104, such as a cellular phone shown in FIG. 3, can communicate with the transponder 106, such as through a Bluetooth link.

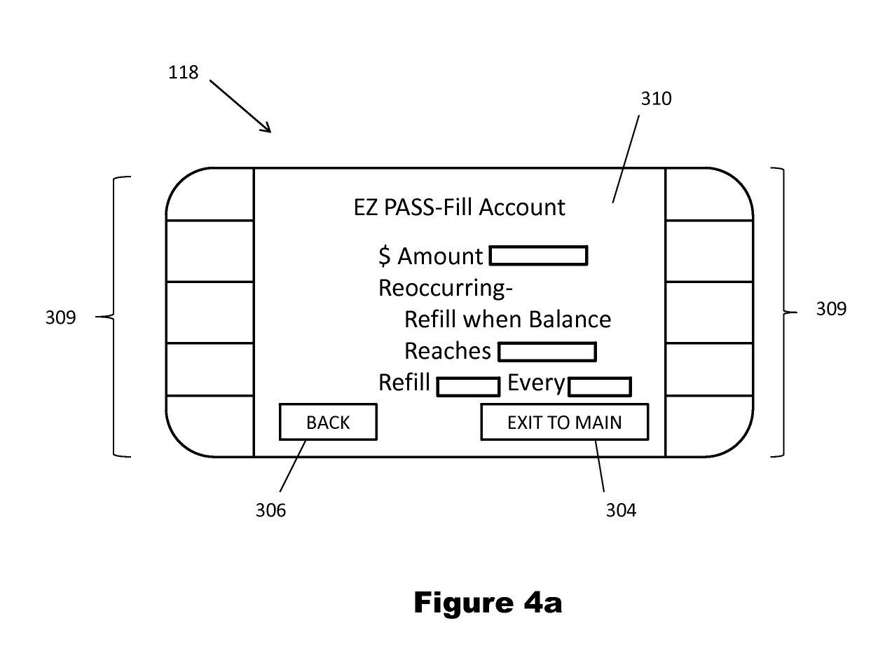

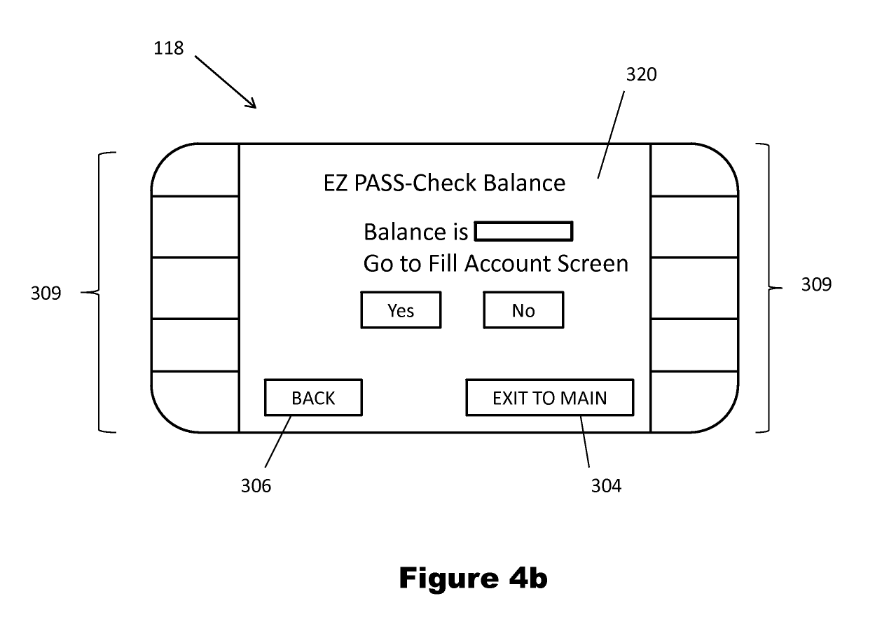

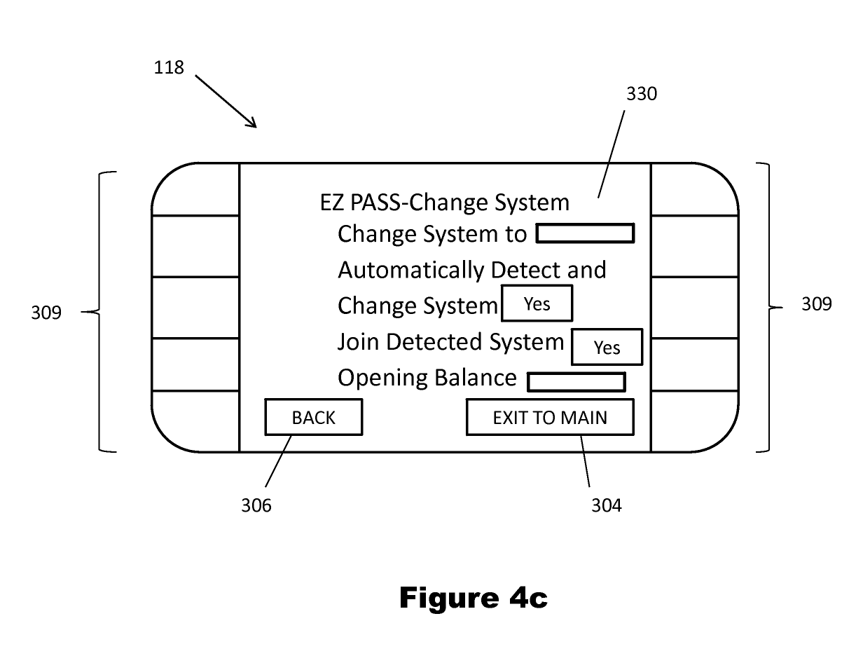

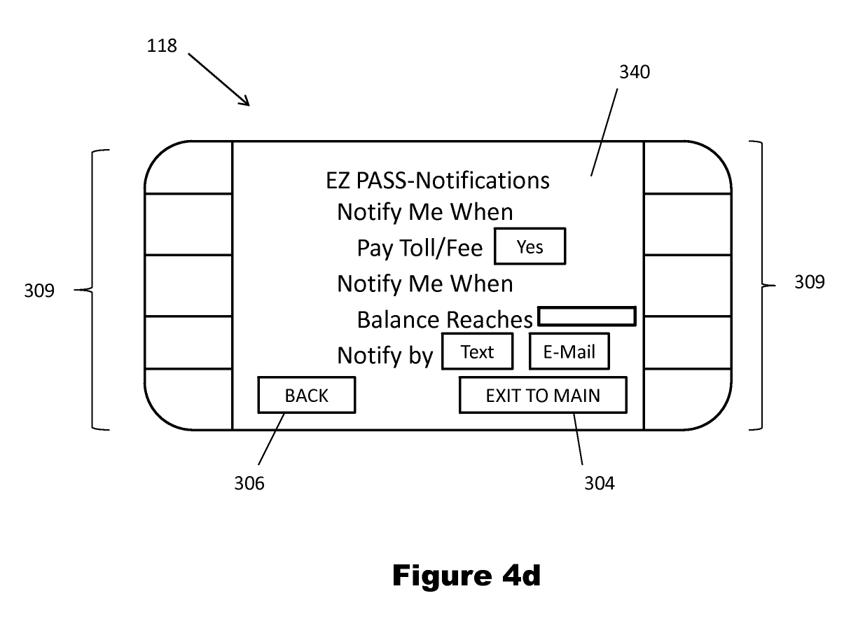

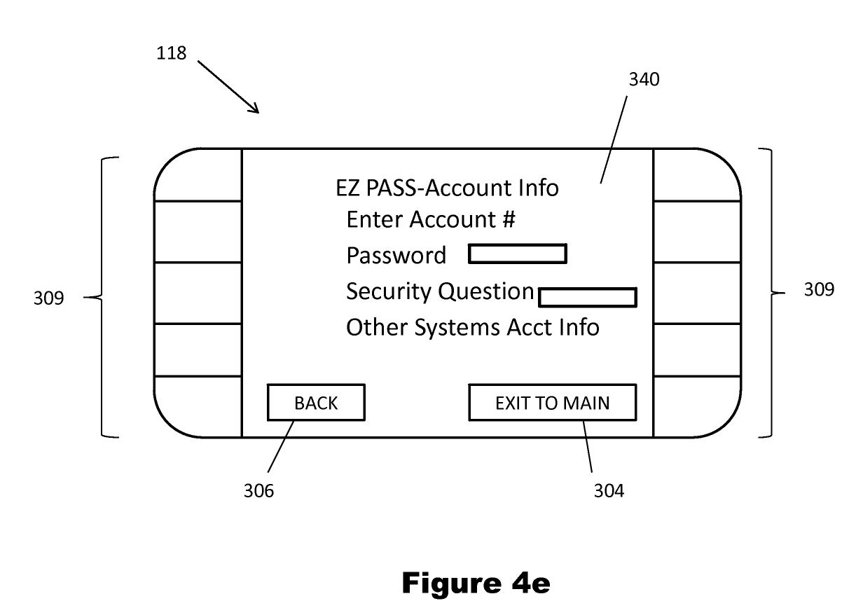

FIG. 3 shows a main menu screen 300 of the display 118 having certain options 302 for the user to choose from. Such choices 300 can include options such as “Fill Account,” “Check Balance,” Change System,” “Notifications” and “Account Info.” Data is entered on the screen (and the following screens) by any means known in the art, such as choosing an option or text box by touch screen, joystick, cursor etc, by entering data into a text box. An exit 304 or back 306 text box choice may also be provided to exit to a main screen of the automobile (or other device) user interface or to move back one screen respectively. Choosing any option 302 can result in displaying another screen having choices corresponding to the selected choice. For example, choosing the “Fill Account” choice on the main screen 300 can result in displaying a “Fill Account” sub menu screen 310 in which additional options relating to the “Fill Account” choice are displayed, as shown in FIG. 4a. Such choices may include entering an amount to be available in the account for use to pay tolls. Selecting such choice requires entering alphanumeric characters of the type consistent with the field. Such entry can be done by pressing buttons 309 proximate to the display (which can also be shared with the operation of the device 102), or touching displayed buttons on a touch screen display. Other options on the “Fill Account” sub menu screen 310 may also include a choice to indicate if a reoccurring amount is desired and a predetermined amount at which the account is replenished when the balance falls below the predetermined amount. Still another option on the “Fill Account” sub menu screen 310 may also include a choice to indicate that the account is to be refilled a certain amount and the frequency at which to refill the account.

The user may choose the “Check Balance” choice on the main screen 300 which can result in displaying a “Check Balance” sub menu screen 320 in which additional options relating to the “Check Balance” choice are displayed, as shown in FIG. 4b. Such sub menu screen may display a balance amount that is available for use to pay tolls and a choice to go to the “Fill Account” screen 310 is the user feels that the balance is too low or if the system automatically determines that the balance is too low by applying one or more criteria to the balance.

The user can choose the “Change System” choice on the main screen 300 which can result in displaying a “Change System” sub menu screen 330 in which additional options relating to the “Change System” choice are displayed, as shown in FIG. 4c. Such sub menu screen may prompt the user to change the toll collection system to another toll collection system because the user has traveled to a different area where the toll collection system is different, for example the user has traveled from NY, where E-Z Pass is used to Florida, where SunPass is used. Alternatively, the user may indicate that the different toll collection systems be automatically detected, in which case the user can receive a notification on the display 118 and be prompted to switch to the detected system, if already having an account, or to join the detected system, if not already a member. Prompts can also be used to enter information for updating information for the detected toll collection system or joining the same.

The user may choose the “Notifications” choice on the main screen 300 which can result in displaying a “Notifications” sub menu screen 340 in which additional options relating to the “Notifications” choice are displayed, as shown in FIG. 4d. Such sub menu screen may display choices for when and how to notify the user of an account, such as notify the user when tolls are paid using his/her account information so as to create a record of the tolls and whether such notification is to be done by e-mail or text (where additional screens allow entering the e-mail address or phone number).

The user may choose the “Account Info” choice on the main screen 300 which can result in displaying an “Account Info” sub menu screen 350 in which additional options relating to the “Account Info” choice are displayed, as shown in FIG. 4e. Such sub menu screen may be used to enter the users account information, such as account number, a password and possibly even security questions. The same sub menu may also be used to enter similar information for additional toll collection systems. Such security systems are well known in the art, such as for on-line banking and can include passwords, security questions and the like.

While the above user interface for operating the transponder is described with regard to an automobile display, those skilled in the art will recognize that the displays of a cellular phone, pad computer, GPS device and laptop may be similarly configured. Furthermore, although a menu and sub-menu configuration is used for the user interface, those skilled in the art will recognize that other types of user interfaces are possible.

Some of the information entered on the user interface requires communication with the toll collection system network 110, which can be done through the local area network at the toll booth when passing or through a communication channel available at the device, such as a cellular network, WiFi network or the like. Alternatively, any changes made can be stored in the device and made with the toll collection system network 110 when a communication channel is subsequently encountered.

Where the toll collection system described above is used to pay fees in general, such as ordering food at a drive through window, the display 118 can include a menu with items to choose from or a text box entry to input order information. Where the device is a cellular phone, pad computer or the like, the display can be driven by an app running on the device. When the items ordered are picked up by the user (customer), the transponder 106 is activated by the vendor's payment system and payment is made similarly to the toll-collection system described above. That is, the transponder responds with account information and food establishment system deducts the amount from the user's account and operates devices accordingly, such as a sign indicating payment and/or a gate for allowing the user to proceed (if in an automobile). Such a system is also shown schematically in FIG. 1a and such device is also shown schematically in FIG. 1b. An app having a user interface for such methods and devices would be similar to those shown in FIG. 3 and FIGS. 4a-4e. With regard to FIG. 3, the main menu may also include menu items or text boxes for entry of item descriptions. With regard to FIG. 4c, such interface may be used if a certain vendor uses a different payment system which is also supported by the device/app. With regard to FIG. 4d, such options are useful to receive receipts by text or e-mail for purchases with the system. Such general fee payment system and method is not limited to users in a vehicle, but can also be used by customers walking into or by a vendor's establishment.

For both the toll collection system and fee payment systems described above, multiple devices may be present in the vehicle or near the vendor establishment when a fee is due. With regard to the fee payment system, only a user ordering an item will be charged. However, the situation becomes more complicated where multiple devices are present (such as in a vehicle) and only one fee is due. Therefore, in order to prevent multiple payments for the same toll/fee, only the user with an application/software open can be charged the toll/fee. Thus, transponders corresponding to devices in which an app is not open will not be activated (e.g., by the power source) and will not respond to the toll collection systems' query signal. In addition, where more than one of the devices may have an open app, logic can be programmed into the network 110 which can detect multiple users with a certain range and only charge one of them. To make sure the correct one is charged, the network 110 can query the devices and ask for payment from one of them. As soon as one of the devices responds positively to accept payment, the other devices need not respond. In addition, the devices itself may “talk” to each other to detect an activated transponder within a certain “close” distance when the transponders are queried by the toll collection system. In such a situation, the devices can query each other to determine who will pay the fee (which transponder will reply to the query). Of course, there may be a situation where all users in a vehicle are to pay a fee (where the charge is per occupant in a vehicle, such as where an auto with multiple occupants enters a ferry or a drive-in theatre), in which case, each of the transponders is activated and must result in a payment. Where the devices query each other as to which one will pay the fee, a choice can be for each to pay the fee.

Furthermore, protocols for securing two-way communication and locking one source to another are well known in the art. Using such protocols, in the presence of many sources and many receivers, only one pair can be securely connected and can communicate. For example, one source (e.g., a vendor) keeps sending a code (a new code for the next customer), then the first device that answers will lock into that code and send back its own special code. This way the two sources will be locked together and will communicate with those codes only. If each device has only one code, then there will be no confusion.

There can also be more than one means for securing communications, for example, when you enter a store, the user of the device can connect to the local network by clicking on an app that shows up on the device, such as on the display of a cell phone, etc., and then the user of the device can set up a secure communication link with the store (similar to the online communication that is made secure) and therefore you have a unique connection with one of your devices only (even if you are in a car with several devices, one device or more can set up their own secure links). Also, the store, etc, link code can be continuously changed (randomly) once a customer has been linked, therefore making it almost impossible for someone else to be able to know what code is coming up, therefore making it almost impossible to get into an already established or future links to do mischief. Other safety means may also be added such as making the link wireless waves highly directional so that the user of the device has to be within a relatively small region to be able to pick up the signal. Alternatively, the store (etc.) can have a sensor (camera or obstruction detection etc.) that their system can detect a customer and if the customer is not there, it knows there is a hacker trying to get into the system.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A device for automatically paying a fee and for performing at least one additional function, the device comprising:
a transponder for emitting an identifying signal responsive to a signal from a fee payment system;
a storage device for storing fee payment system information to be emitted in the identifying signal;
a display for displaying fee payment information; and
a processor for controlling the transponder, storage device and display;
wherein at least one of the storage device, display or processor is used for both the operation of the transponder and for operation of the at least one additional function of the device.

2. The device of claim 1, wherein the device is one of a cellular phone, pad computer, GPS device and laptop computer.

3. The device of claim 2, wherein the device further comprises a communication link and the processor controls both the operation of the transponder and the operation of the communication link.

4. The device of claim 3, wherein the communication link includes a transducer and the processor controls the transducer to communicate both with the fee payment system and for one or more of cellular communication, Bluetooth communication and GPS reception.

5. The device of claim 2, wherein the storage device stores the fee payment system information and information and content for use with the one of the cellular phone, pad computer, GPS device and laptop computer.

6. The device of claim 2, wherein the device further comprises a GPS receiver and the processor controls the transponder for operation of the fee payment system and the GPS receiver for location information useful for operation of one of the cellular phone, pad computer, GPS device and laptop computer.

7. The device of claim 2, wherein the processor controls the display to display the fee payment information and information used in the operation of one of the cellular phone, pad computer, GPS device and laptop computer.

8. The device of claim 2, wherein the device further comprises a power source for providing power for operation of the transponder and operation of the at least one additional function of one of the cellular phone, pad computer, GPS device and laptop computer.

9. The device of claim 1, wherein the device is an automobile.

10. The device of claim 9, wherein the processor controls the operation of the transponder and the operation of at least one function of the automobile.

11. The device of claim 9, wherein the device further comprises a communication link and the processor controls both the operation of the transponder and the operation of the communication link.

12. The device of claim 11, wherein the communication link includes a transducer and the processor controls the transducer to communicate both with the fee payment system and for one or more of cellular communication, Bluetooth communication and GPS reception.

13. The device of claim 9, wherein the storage device stores the fee payment system information and information and content for use with the automobile.

14. The device of claim 9, wherein the device further comprises a GPS receiver and the processor controls the transponder for operation of the fee payment system and the GPS receiver for location information useful for operation of automobile.

15. The device of claim 9, wherein the processor controls the display to display the fee payment information and information used in the operation of the automobile.

16. The device of claim 9, wherein the device further comprises a power source for providing power for operation of the transponder and operation of the at least one additional function one of the automobile.

17. The device of claim 9, wherein the transponder is disposed at one of a dashboard, front grill and headlamp of the automobile.

18. The device of claim 1, wherein at least one of the transponder, storage device, display and processor is provided in one of a cellular phone, pad computer, GPS device and laptop computer and the other of the transponder, storage device, display and processor is/are provided in an automobile.

19. A rearview mirror assembly for use with a windshield of an automobile, the rearview mirror assembly comprising:
a mirror; and
a transponder for emitting an identifying signal responsive to an signal from a fee payment system.

20. The rearview mirror assembly of claim 19, further comprising an electrical connection for electrically connecting the transponder to one or more of a storage device for storing fee payment system information to be emitted in the identifying signal, a display for displaying fee payment information; a power source for providing power for operation of the transponder and a processor for controlling the transponder, storage device and display; wherein at least one of the storage device, display, power source and processor is used for both the operation of the transponder and for operation of the automobile.

21. The rearview mirror assembly of claim 19, further comprising:
a body portion for at least indirectly supporting the mirror on or near the windshield; and
a module removably disposed on the body portion, the module holding the transponder.

22. The rearview mirror assembly of claim 21, wherein the module further holds one or more of a storage device for storing fee payment system information to be emitted in the identifying signal, a processor for controlling the transponder and a power source for providing power for operation of at least the transponder.
